(19) United States
(12) Patent Application Publication
(10) Pub. No.: US 2006/0171782 A1
(43) Pub. Date: Aug. 3, 2006

(54) Pipe bedding system

(76) Inventor: Nathan Ray Neiwert, Idaho Falls, ID (US)

Correspondence Address: THORPE NORTH & WESTERN, LLP., 8180 SOUTH 700 EAST, SUITE 200, SANDY, UT, 84070, US

(21) Appl. No.: 11/337,124

(22) Filed: Jan. 19, 2006

Related U.S. Application Data
(60) Provisional application No. 60/645,450, filed on Jan. 20, 2005.

(51) Int. Cl. F16L 1/028

(52) U.S. Cl. 405/179

(57) ABSTRACT

A system for preparing earthen beds for installation of pipe thereon comprises a trench support frame, disposable at least partially within an earthen trench in which pipe is to be installed. A grading assembly is coupled to and movable within the trench support frame. A bedding material supply system is integrated with the trench support frame, the bedding material supply system being configured to provide bedding material to be graded by the grading assembly to prepare a floor of the earthen trench for installation of the pipe within the trench.

### BACKGROUND OF THE INVENTION

1. Field of the Invention

The present invention relates generally to systems for preparing earthen beds for receiving pipe, conduit and similar equipment.

2. Related Art

Installing pipe, conduit and related materials (hereinafter referred to as “pipe,” “pipes” or “piping”) on earthen beds has been done for many years. In many such cases, the pipes are laid on an earthen bed and covered by earthen fill materials to form an underground pipe system. Nearly all conventional utility services utilize underground piping to transport water, sewage, fuel, etc.; or to house wiring, cabling or similar material. Such piping systems must generally be installed with a relatively high degree of accuracy, to ensure that the pipes allow unrestricted and proper flow of fluids and gasses through the pipes. Also, as the piping and conduit system utilized is often covered by, or buried beneath, the ground surface after installation of the piping, the pipe system is often subject to large compressive loads which can lead to distortion or breaking of pipe systems if the bed on which the pipe has been laid is not carefully and accurately prepared.

Over the years, standard procedures have been developed that are used by many contractors when installing piping or conduit systems. As pipe systems are often buried several feet below the ground surface, motorized excavators are used to dig a trench in which the pipe system will be installed. In one typical pipe laying scenario, a hydraulic excavator is utilized to dig a trench in the ground that is sufficiently deep to lay the piping being installed and is also sufficiently wide to contain what are commonly known as “trench boxes,” which aid in retaining the walls of the trench from collapsing and potentially injuring or killing operators working within the trench to lay the pipe.

In such a scenario, the floor of the trench is generally dug to a level approximately six inches below the “flow line” level of the pipe being installed. After the trench is dug, a trench box is lifted into the trench by the excavator to shore the sides of the trench before operators are allowed to enter the trench. The excavator then generally applies bedding material onto the floor of the trench and attempts to “pull grade” with the bucket of the excavator to smooth the bedding material into a level, smooth surface of consistent elevation to support the undersurface of the pipe. Due to the complexity of this operation, the surface of the trench must often be further leveled and groomed manually by operators working within the trench before the pipe can be laid.

Once the trench is prepared for installation of pipe, pipelayers then align and assemble the pipe or pipes to be installed in the section of the trench that has been prepared. Installation of pipe often involves cutting, fitting or cleaning pipe, and joining or fitting of the pipe. In a typical scenario, the operator of the excavator is generally sitting idle while the pipe fitting is taking place, waiting until his or her next involvement in the process.

Once the pipe system has been properly installed, the excavator then generally partially covers the pipe with more bedding material. After this point, the pipelayers generally must compact the bedding partially covering the pipe using hand-held pneumatic compactors (often referred to as “pogos” or “single legs”). The compacting process usually focuses on compacting the material into the “haunches,” or below the two side curvatures of the pipe on the lower circumference of the pipe. After the pipes are in place and the fill has been properly compacted, the excavator operator generally applies a final level of bedding over the pipe. Only after this process is complete can the excavator operator begin preparing the next section of trench to continue installation of the remaining pipe system.

Thus, during much of the conventional pipe laying process, the excavator (and, likely, the excavator operator) sits idle while waiting for further work to be performed by other operators before the excavator can proceed to its next step. As most excavators cost hundreds of dollars per hour to operate, this inactivity results in major inefficiencies in the pipe laying process. Similarly, while the excavator is working, the pipelayers are often sitting idle waiting to proceed to their next step. In addition to the pipelayers within the trench, many conventional operations also utilize a “top man” who works from ground level (above the trench) to assist the pipe layers. This top man is also generally sitting idle during much of the excavator work.

To illustrate the timeframes associated with conventional pipe laying, it has been found than an excavator operator can dig a “set” (e.g., a length of trench roughly corresponding to the length of a conventional trench box) to a depth of about ten (10) feet in about three (3) minutes. However, the total cycle time (e.g., the time to begin and end laying pipe within the set) is on the order of thirteen (13) minutes, due to the time required for laying of the pipe, compaction, top fill, etc. Thus, the work for which the excavator is best suited, e.g., digging the trench itself, consumes less than a fourth of the time required to lay a set of pipe. The remainder of this time is often spent by the excavator waiting for other operators to complete their tasks.

### SUMMARY OF THE INVENTION

It has been recognized that it would be advantageous to develop a pipe bedding system that increases the time rate at which trench beds can be prepared and pipe can be installed, and which can more efficiently utilize personnel and equipment required in the trench forming and pipe installation process.

The invention provides a system for preparing earthen beds for installation of pipe thereon, including a trench support frame, disposable at least partially within an earthen trench in which pipe is to be installed. A grading assembly can be coupled to and can be movable within the trench support frame. A bedding material supply system can be integrated with the trench support frame, the bedding material supply system being configured to provide bedding material to be graded by the grading assembly to prepare a floor of the earthen trench for installation of the pipe within the trench.

In accordance with another aspect of the invention, a system for preparing earthen beds for installation of pipe thereon is provided, including a trench support frame, disposable at least partially within an earthen trench in which pipe is to be installed. A surface grading device can be associated with the trench support frame. A concrete mixture supply apparatus can be integrated with the trench support frame, the concrete mixture supply apparatus being configured to provide a layer of concrete within the earthen trench, the layer of concrete to be graded by the surface grading device to prepare the layer of concrete for installation of the pipe within the earthen trench.

In accordance with another aspect of the invention, a method for preparing an earthen bed for installation of pipe thereon is provided, including placing a trench support frame at least partially within an earthen trench in which pipe is to be installed; providing a bedding material within the earthen trench on which the pipe is to be installed, wherein the bedding material is provided using a bedding material supply apparatus integrated with the trench support frame; and forming a channel in the bedding material, the channel configured to receive the pipe to be installed, wherein the channel is formed using a surface grading device associated with the trench support frame.

Additional features and advantages of the invention will be apparent from the detailed description which follows, taken in conjunction with the accompanying drawings, which together illustrate, by way of example, features of the invention.

### BRIEF DESCRIPTION OF THE DRAWINGS

FIG. 1 is a top, schematic view of a pipe bedding system installed within a trench in accordance with an embodiment of the present invention;

FIG. 2 is a side, schematic view of the pipe bedding system of FIG. 1;

FIG. 3 is a top, schematic view of a grading assembly in accordance with an embodiment of the invention;

FIG. 4 is a side, schematic view of the grading assembly of FIG. 3;

FIG. 4A is front, sectional view of a shoe and channeling protrusion of the grading assembly of FIG. 4;

FIG. 4A′ is a front view of a blade and channeling protrusion of the grading assembly of FIG.3;

FIG. 4B is a sectional view of a pipe lying on a filler bed prepared in accordance with a prior art method;

FIG. 4C is a sectional view of a pipe lying on a filler bed prepared in accordance with the present invention;

FIG. 5 is a side, schematic view of portions of a movable carriage in accordance with an embodiment of the invention;

FIG. 6 is a schematic, front end view of a trench support frame in accordance with an embodiment of the invention;

FIG. 7 is a schematic of an array of photosensors in accordance with an embodiment of the invention;

FIG. 8 is a schematic view of a hydraulic system in accordance with an embodiment of the invention; and

FIG. 9 is a schematic view of additional components of the system of FIG. 9 in accordance with an embodiment of the invention;

FIG. 10 is a schematic, top view of the pipe bedding system with two material supply apparatuses integrated within a trench support frame in accordance with an embodiment of the invention;

FIG. 11A is a schematic front view of the pipe bedding system of FIG. 10, showing a first material supply apparatus in use in accordance with an embodiment of the invention;

FIG. 11B is a schematic front view of the pipe bedding system of FIG. 10, showing a second material supply apparatus in use in accordance with an embodiment of the invention;

FIG. 12A is a schematic sectional view of a first end of a surface grading device configured to fit over a section of pipe, in accordance with an embodiment of the invention;

FIG. 12B is a schematic sectional view of a grading sled to which a channeling protrusion is coupled in accordance with an embodiment of the invention;

FIG. 12C is a schematic sectional view of a second end of a surface grading device having a target configured for receiving a laser beam in accordance with an embodiment of the invention;

FIG. 12D is a schematic top view of a surface grading device coupled to the grading sled in accordance with an embodiment of the invention; and

FIG. 12E is a schematic side view of a surface grading device coupled to a height adjustable unit in accordance with an embodiment of the invention.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

The present invention provides a system for preparing earthen beds, in particular trench beds, for installation, or “laying,” of pipe within the trench. In one embodiment, the invention includes three primary components: i) a trench support frame; ii) a grading assembly comprising a carriage, moveable within the support frame and having a grading blade coupled thereto; and iii) a bedding material supply system, associated with the moveable carriage. In use, the trench support frame is disposed within a trench that has been, or will be, dug to a depth slightly below the level at which the pipe will be laid. The trench support frame serves the dual purposes of shoring the sides of the trench to protect pipelayers who will be working within the trench and of providing a support which allows the carriage to move lengthwise within the trench.

Once the trench support frame is in place within the trench the bedding material supply system can feed bedding material to the trench floor while the carriage moves within the support frame from one end of the frame to another. The bedding material can include any substantially incompressible fill material, including but not limited to soil, road base, and concrete mixture. The bedding material may be mixed with other materials, such as hydrating solutions, to enable more rapid compaction of the bedding material.

As the carriage moves, the grading blade can grade and at least partially compact the bedding material to specification. Once the carriage, and grading blade, has traversed the length of the trench support frame, the floor of the trench is in condition to receive the pipe which is to be laid. At this point, the trench frame can be moved to the next section of trench (which can have been prepared by the excavator while the system was grading the first section of trench). The trench frame can be moved in a number of manners, including by use of the excavator which was used to dig the trench sections.

The present invention thus provides a self-contained system that shores the sides of the trench in which pipe is to be laid and also grades the bed of the trench into condition to receive a pipe or pipes for installation into a pipe system. The system accomplishes this while eliminating several steps necessary in conventional trench bed systems, that is, without requiring that the excavator apply fill material to the trench and pull a rough grade in the trench, and without requiring human operators to finish the rough grade applied by the excavator prior to laying the pipe in the trench.

The present invention provides several advantages over the prior art. For example, as the excavator and pipelayers need not wait for one another as often, the efficiency of the entire process is increased. It has been found that the present invention decreases the time per “set” from 13 minutes total to 8 minutes total, and less. In addition, in those embodiments in which fill material is utilized, as the fill material is more carefully and accurately bedded in the trench, the amount of fill material can be reduced by ⅔ or more while also increasing the smoothness and accuracy of the grade bedded in the trench.

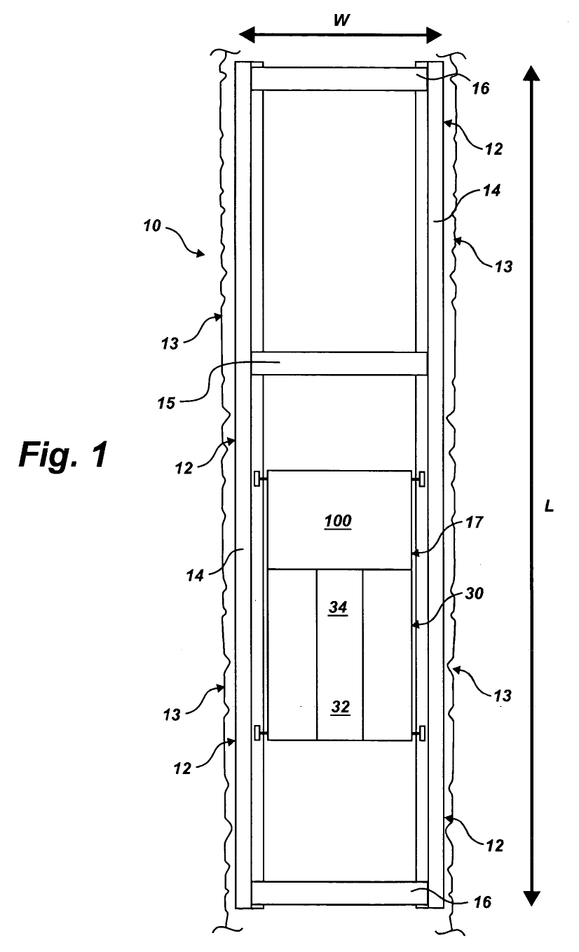

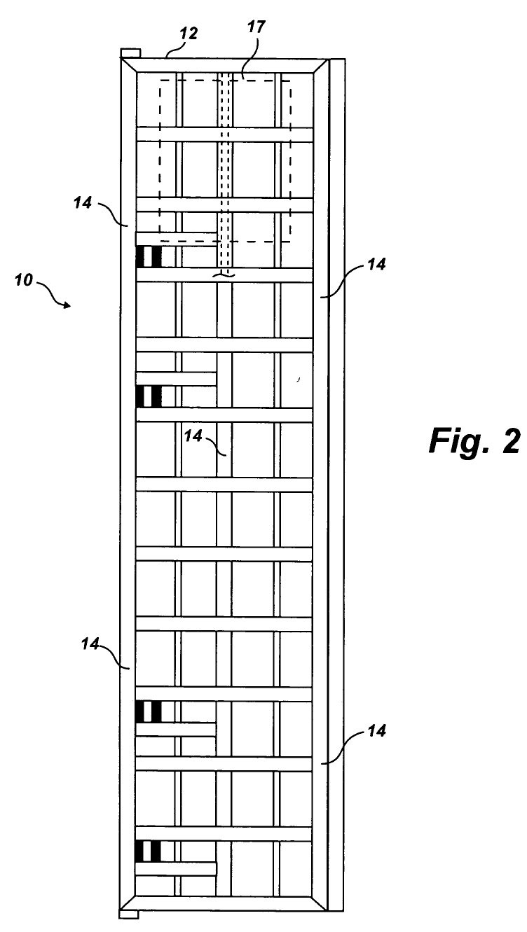

Described in more detail, and as illustrated schematically in top view in FIG. 1 and in side view in FIG. 2, in one embodiment the system 10 can include a trench support frame 12. The trench support frame can be disposed at least partially within a trench (shown in FIG. 1 having sides 13) in which pipe (not shown) is to be installed. The trench support frame can be similar to those used in conventional trenching systems which generally serve to retain the earthen walls of the trench from collapsing inwardly before the trench is no longer desired. The frame is generally composed of various lengthwise supports, such as longitudinal supports 14, and various cross supports, such as spreader 15 and end supports 16. The trench support frame can be provided in a number of lengths, including an overall length L on the order of thirty feet. Similarly, the trench support frame can be provided in a number of widths, including an overall width (W in FIG. 1) just over about six feet (generally, six feet of clearance is available within the trench support frame). The trench support frame can also be configured such that the width of the frame can be easily adjusted, to enable use of the frame within trenches formed in a variety of widths, as would occur to those skilled in the relevant art.

The trench support frame can be used much like conventional trench boxes that are first placed within a trenched location and remain in place until the pipe laying to be done in that location is complete. Once the process is complete, the entire trench support frame can be lifted (such as with an excavator) and moved down line to the next location in which pipe is to be laid. In this manner, the trench support frame is moved incrementally along a length of a pipe installation until the entire length of pipe has been assembled and seated.

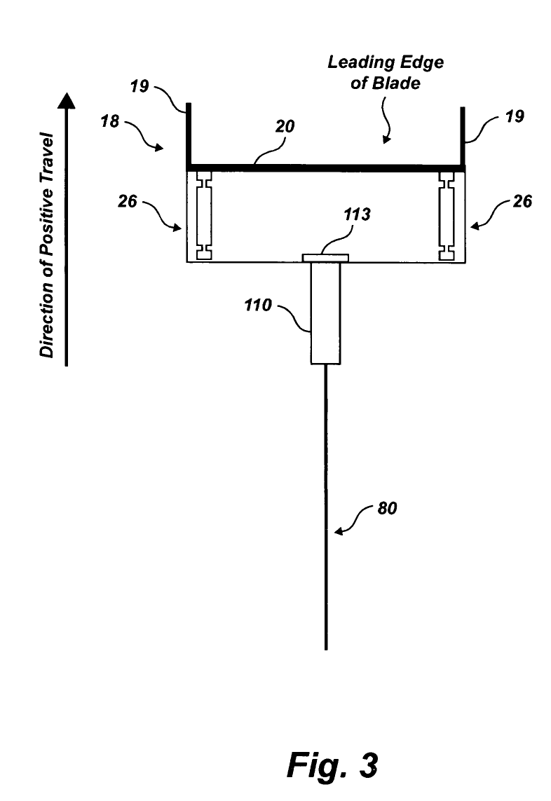

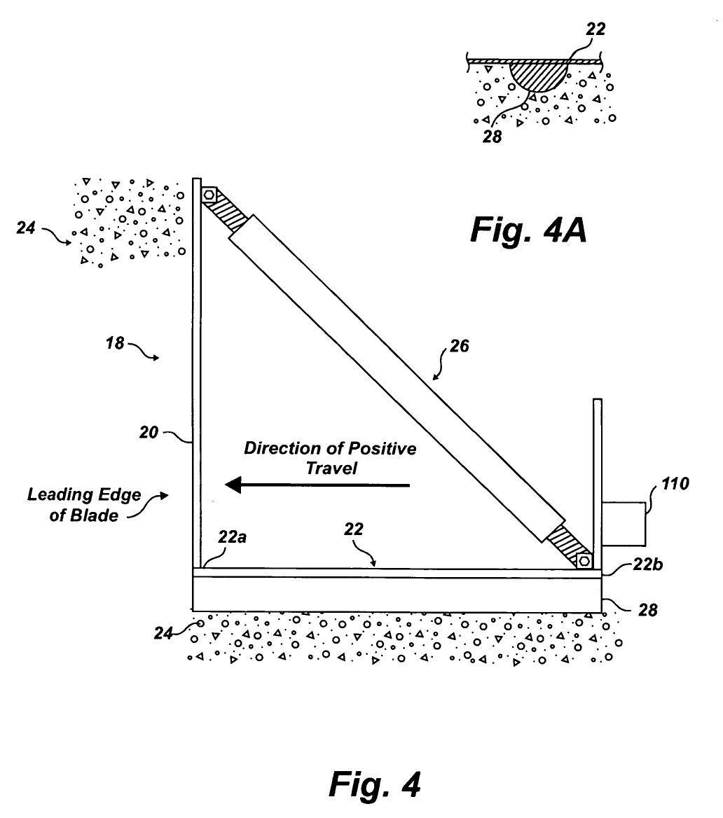

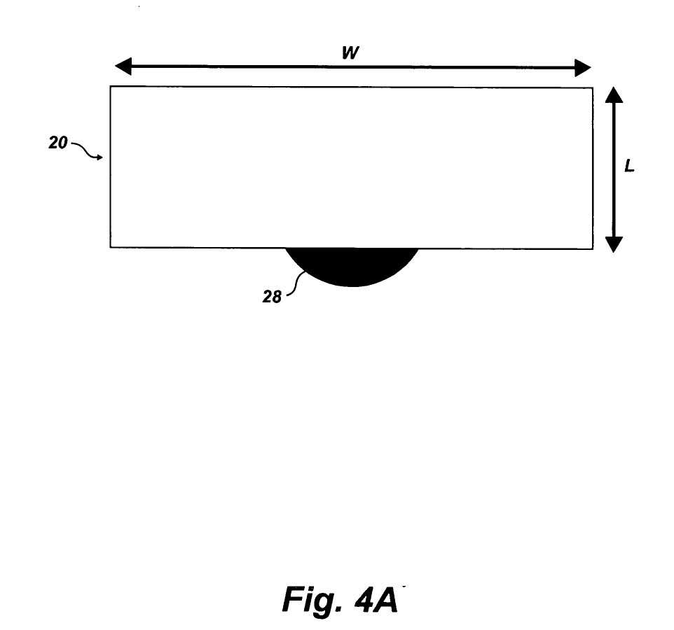

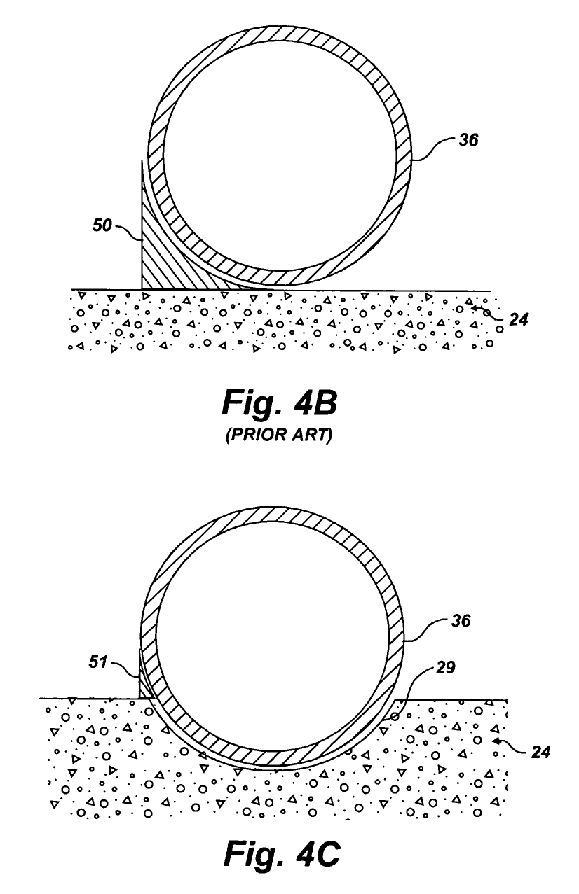

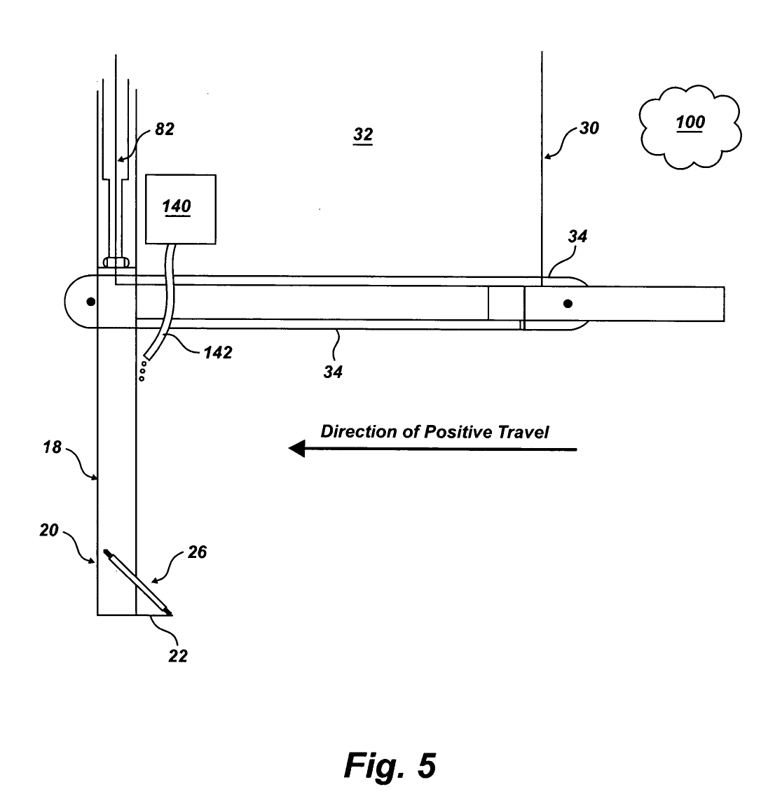

Unlike convention trench boxes or frames, however, which merely shore the sides of the trench in which pipe is to be laid, the present invention can include a movable carriage (shown generally at 17) which can carry a variety of auxiliary systems, including a grading assembly 18, shown in top view in FIG. 3 and in side view in FIGS. 4 and 5. As part of the moveable carriage, the grading assembly is movable within the trench support frame 12 and grades fill material within the trench as the carriage moves along the direction of positive travel (shown in FIGS. 3 and 4). As best shown in FIG. 4, the grading assembly 18 can include a leading blade 20 and a trailing shoe 22. The trailing shoe 22 can be pivotally coupled to the leading blade 20. The blade and shoe cooperate to compact bedding 24 which is fed downward in front of the blade as the grading assembly is moved along the direction of positive travel (the bedding is fed to the blade via a bedding material supply system, as discussed in more detail below). Thus, as the grading assembly moves in the direction of positive travel shown, the blade and shoe smooth and compact the bedding material to the desired grade and compaction value. In one embodiment, blade wings 19 (FIG. 3) can be used to help control the spread of the bedding material as it is compacted by the blade 20 and shoe 22.

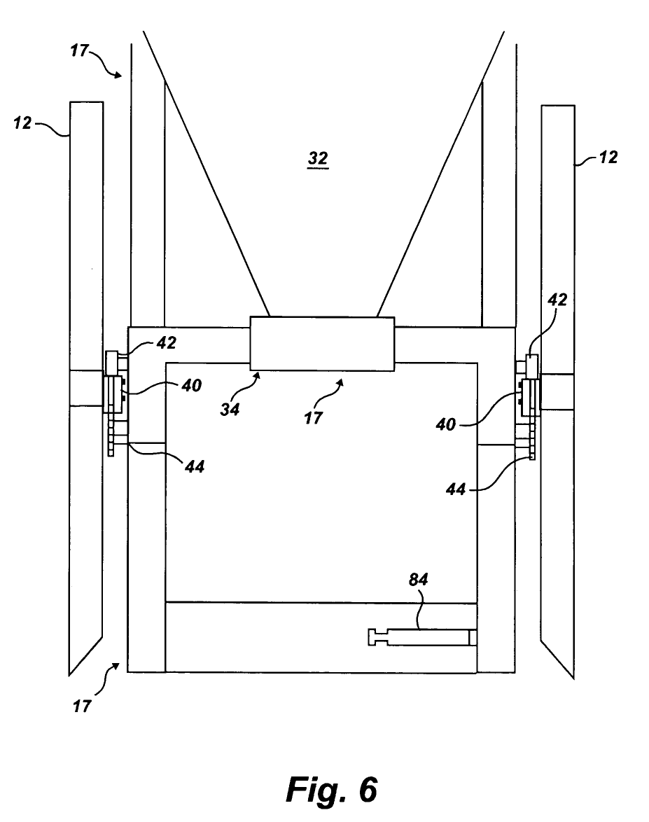

The moveable carriage 17 can be coupled to the support frame in a variety of manners that allow linear movement of the carriage within the frame. In the embodiment shown in front, end view in FIG. 6, a pair of rails 40 run the length of the trench support frame 12 to slidably support the carriage. A pair of upper rollers 42 ride on top of the rails while a pair of lower rollers, or drive gears 44, engages the bottom of the rails. In this manner, the carriage is free to slide along the length of the support frame 12 but is held from being displaced upwardly or downwardly within the carriage. Thus, as the carriage is driven along the length of the support frame (by methods discussed in more detail below), the weight of the support frame prevents the grading assembly 18 from moving upward in response to forces incurred while grading and compacting the bedding fill. In one embodiment of the invention, the weight of the support frame is on the order of 24,000 lbs, without any fill material stored in the hopper of the bedding material supply system (discussed in more detail below). It has been found that this weight is sufficient to maintain the support frame, and thus the carriage and grading assembly, in a desired vertical position while grading the bedding fill material.

The leading blade 20 and the trailing shoe 22 of the grading assembly 18 can be adjusted relative to one another to increase an angle of the trailing shoe from horizontal. In the embodiment shown in FIG. 4, a turnbuckle assembly 26 is provided to lower or raise a trailing edge 22b of the shoe. It will be appreciated that, should the trailing edge of the shoe be higher than the leading edge 22a of the shoe, the shoe will only nominally contact any fill material, as the blade 20 will gouge or scrape the fill material to a level lower than the trailing edge of the shoe. If the trailing edge of the shoe is lower than the leading edge of the shoe (and thus lower than a bottom section of the blade), the trailing edge of the shoe will provide the final grade to the fill material.

It will also be appreciated that as the trailing edge 22b of the shoe applies the final grade to the fill 24, the fill will likely be compacted to some degree due to the force applied by the trailing edge of the shoe. Thus, the angle between the shoe 22 and the blade 20 can be adjusted to alter both a level of the grade applied to the fill material and a level of compaction applied to the fill material. In addition to the compaction that will occur as a result of the grading process, it is contemplated that vibratory means can be coupled to the blade 20 and/or the shoe to achieve further compaction, where desired. Such vibratory means are known to those of skill in the art and could be incorporated readily into the structure shown and described herein.

The carriage 17, and accompanying grading assembly 18 and material supply system 30, can be driven along the length of the trench support frame 12 in a variety of manners. In one embodiment, one or more drive gears can replace one or more of the rollers 42, 44 and drive the carriage along rails 40. In another embodiment, hydraulic actuators (not shown) can be used to drive the carriage lengthwise within the support frame. It is also contemplated that a series of cables and pulleys can be utilized. Each of these various force components can be powered, either directly or indirectly, by the engine, hydraulics, and associated controls 100 discussed in more detail below.

FIG. 4A (located in the upper right corner of FIG. 4) illustrates a section of the shoe 22 illustrated in FIG. 4. In this embodiment of the invention, the shoe includes a channeling protrusion 28 which extends downwardly from the shoe 22. The channeling protrusion can include a cross sectional shape that is substantially the same as a lower portion of the pipe to be laid (36 in FIGS. 4B and 4C). Shown schematically in FIG. 4C, as the shoe is drug along the fill material 24, the channeling protrusion gouges a channel 29 in the fill material, the channel having a shape that substantially matches the cross section of the pipe to be laid. In this manner, as the pipe is laid within the channel 29, the pipe is supported about much of its lower cross section without requiring that additional fill material to be applied under and about the pipe.

FIG. 4B illustrates a conventional, prior art pipe bedding system wherein fill material 24 has been simply graded to a level surface. In this scenario, only the lowermost portion of the pipe is in contact with the fill material and must be supported by the addition of more fill material, which is generally compacted below and about the lower section of the pipe by manual methods, such as by the use of pogo sticks. In contrast, the channel 29 formed by the channeling protrusion 28 (FIG. 4A) of the shoe 22 during the grading process can receive a pipe which is supported by the curved walls of the channel. In this manner, it has been found that no further addition of fill material may be needed to support the pipe and, accordingly, that no compaction may be necessary after installing the pipe in the channel.

The sections 50 and 51 of FIGS. 4B and 4C, respectively, illustrate this concept. In FIG. 4B, it can be seen that a quantity of fill material 50 is required to support pipe 36 laid on a conventional, flat bed of filler material 24 (an equal quantity being also necessary on the opposite side of the pipe). However, in the present invention, only a relatively small quantity of fill material 51 may be needed to support the upper portions of the pipe not supported by the channel 29 formed during the grading process. In some processes in which the present invention has been used it has been found that the addition of fill material 51 is not necessary, as a sufficiently large percentage of the cross section of the pipe is supported by the channel 29 so as to resist any distortion or breakage of the pipe upon backfilling the trench.

As the channeling protrusion 28 of the shoe 22 can be tailored to match the cross section of the pipe being laid, it is contemplated that the channeling protrusion 28 can be removably attached to the shoe via methods known to those skilled in the art. In this manner, the channeling protrusion can be exchanged when pipes of larger or smaller diameter are being laid.

As briefly discussed above, the grading assembly 18 (FIG. 5) can be fed with bedding material 24 via a bedding material supply system 30 which can be provided as an integral part of the trench support frame 12 or carriage 17 (note that the pattern used to indicate bedding material is intended to indicate a generic filling material and is not limited to any material commonly represented by a particular drafting pattern). In the aspect of the invention shown in FIGS. 1, 5 and 6, the bedding material supply system includes a hopper 32 and a conveyor 34. The hopper can be loaded with “clean” bedding material in preparation of operating the system and can be controlled (by methods discussed in more detail below) by an operator to release bedding material to the conveyor belt as the carriage progresses along the length of the support frame.

The conveyor 34 can in turn feed the material 24 in front (relative to a direction of positive travel) of the grading assembly 18 to ensure that sufficient fill material is present to fill and smooth the pipe bed adequately. The positive direction of travel is related to the direction of the leading edge of the blade 20. The blade 20 is designed to compact and level the bedding material. Thus, the positive direction of travel can be in either direction, depending on the direction in which the leading edge of the blade 20 is assembled.

The hopper 32 and conveyor 34 can be operated by a variety of methods known to those in the art, including by manual or automatic operation. In one aspect of the invention, the hopper 32 and conveyor 34 can be configured (via control circuitry shown generally at 100) to feed a predetermined amount of filler material per linear unit of travel of the carriage 17. Alternately, manual controls can be provided which can allow an operator to advance or retard the rate of fill material as the operator monitors the grading process.

In the embodiment illustrated in FIG. 5, the hopper 32 is shown coupled above the conveyor 34 and each of the conveyor and hopper travel with the carriage 17 to deliver fill material as the carriage 17 travels along the length of the support frame 12. While this configuration has proved effective, it is to be understood that the bedding material supply system can be configured to provide fill material in a number of manners, as would occur to one skilled in the relevant art. For example, it is contemplated that the hopper could have a flexible delivery conduit attached thereto to enable an operator to control the placement of the fill material as it leaves the hopper, thereby obviating the need for a conveyor system.

As shown in FIG. 5, the present invention can also incorporate a water tank 140 and associated water delivery mechanism 142 which can collectively apply water to the fill material as it is discharged by the conveyor. In this manner, moisture can be added to the fill material to alter the compaction qualities of the fill material. As in other assemblies of the invention, the water delivery system can be automated to more or less constantly apply water to the fill material as it leaves the conveyor, or it can be manually operated, to allow an operator to add water to the filler material as he or she observes the grading and compaction process.

As shown in FIGS. 3 and 4, in one aspect of the present invention the system includes a guidance system which can be operatively coupled to at least one of the trench support frame 12 and the grading assembly 18. In another embodiment, the guidance system can be operatively coupled between the trench support frame 12 and the grading assembly 18. In the embodiment shown, the guidance system includes a laser targeting box 110 which contains sensing and control circuitry that provide for automatic detection of a laser, and control of the grading assembly in response to thereto. The targeting box can be coupled to a laser target mount 113 located adjacent or on the grading assembly 18. The guidance system is generally configured to allow adjustment of the grading assembly to maintain a desired grade within the trench and a desired directionality of the channel 29 gouged in the bedding material 24.

In many pipe laying processes a laser is utilized to ensure that the pipes are laid in accordance with a particular specification. To facilitate this process, a laser is often directed in the precise path in which a pipe run must travel and each pipe installed in the pipeline is carefully centered about the line of the laser. Various accessories are available to pipelayers to allow them to follow the laser as pipes are laid in the pipeline. During conventional pipelaying methods, a trench floor is graded to an estimated level and the pipelayer is responsible for fine-tuning the grade of the trench floor while the pipe is laid to ensure each pipe is supported in a position collinear with adjacent pipes. While this conventional process can result in accurately laid lines of pipes, the process of aligning and coupling each pipe to an adjacent pipe is often time consuming and onerous.

The present invention addresses this issue by gouging a channel (29 in FIG. 4C) in the trench floor during the grading process and ensuring that the channel defines a profile that will match a pipe resting in the channel, resulting in the channel nearly fully supporting the undersurface of the pipe. The slope and direction of the channel is controlled by the laser targeting box 110, in cooperation with vertical and horizontal adjustments made to the grading system, operating on an incoming laser signal (80 in FIG. 3). The laser signal is generally established as in conventional systems by installing the laser “up line” of the pipe currently being installed. The laser targeting box, which in this embodiment is coupled directly to the grading assembly (see FIG. 4), reads the laser beam and signals control circuitry which results in adjustment of the horizontal and vertical position of the blade 20 (and correspondingly the shoe 22).

Adjustment of the vertical location of the blade 20 and shoe 22 can be made via vertical hydraulic cylinders (82 in FIG. 5) which increase or decrease elevation of the grading assembly 18 relative to the support frame 12. Adjustment of the horizontal (or side-to-side, relative to the length of the trench) position of the blade and shoe is made via horizontal hydraulic cylinders (84 in FIG. 6). Thus, as the carriage 17 moves along the length of the trench in the positive direction of travel, the laser targeting box 110 continually senses the position of the blade and shoe relative to the laser and signals either or both of the vertical or horizontal cylinders to adjust the blade and shoe (and the channeling protrusion 28) accordingly. In this manner, once the grading process is complete, the channel 29 that has been gouged into the filler material will receive the pipe to be installed in a nearly perfect match with the specified grade and alignment of the pipe.

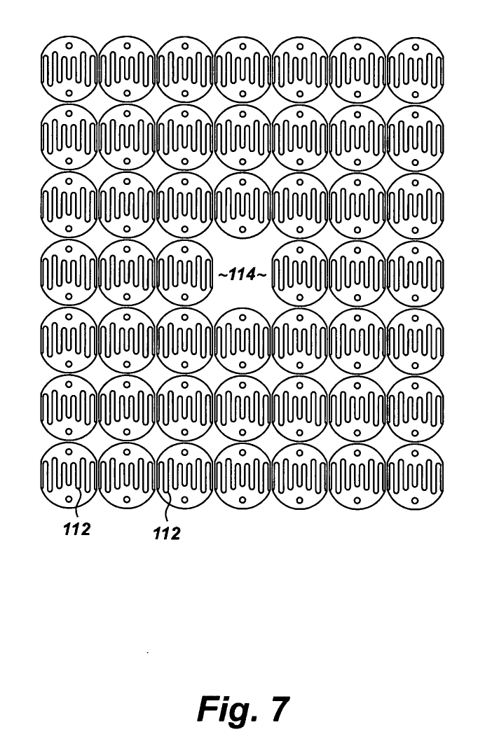

The laser targeting box shown in FIG. 3 can be configured in a variety of manners. In the embodiment illustrated in FIG. 7, the targeting box can include an array of detectors 112 such as photosensors which are each capable of detecting the laser beam 80 (FIG. 3). In the event the laser beam is directed to the “null position” 114, the targeting box detects that the blade 20 and shoe 22 (FIG. 4a) are correctly positioned. When the blade and shoe are correctly positioned the targeting box is configured to enable the blade and shoe to remain in a fixed position as they are moved over the pipe bed. In the event one of the photosensors detects the laser beam, control circuitry associated with the target box can activate either or both the horizontal or vertical hydraulic pistons until the blade and shoe are correctly positioned and the target box again senses a null position. This can enable the blade and shoe to maintain a desired grade within the trench and a desired directionality of the channel gouged in the bedding material. To aid in ensuring that the photosensors do not detect false signals, one or more filters 116 can be installed in the target box to exclude light having a wavelength different from the laser being used. In practice the target box may include a sealed configuration, allowing only the laser beam light to enter the box and contact the photosensors 112 (FIG. 7).

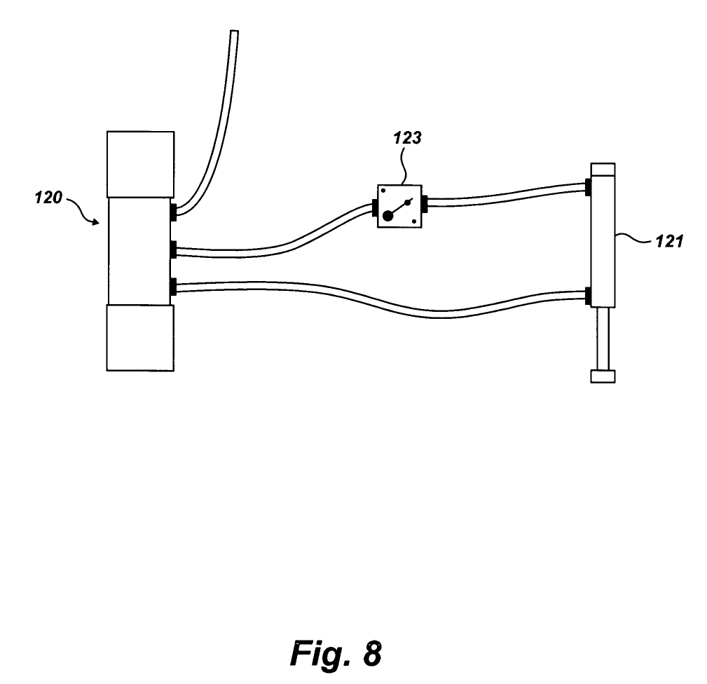

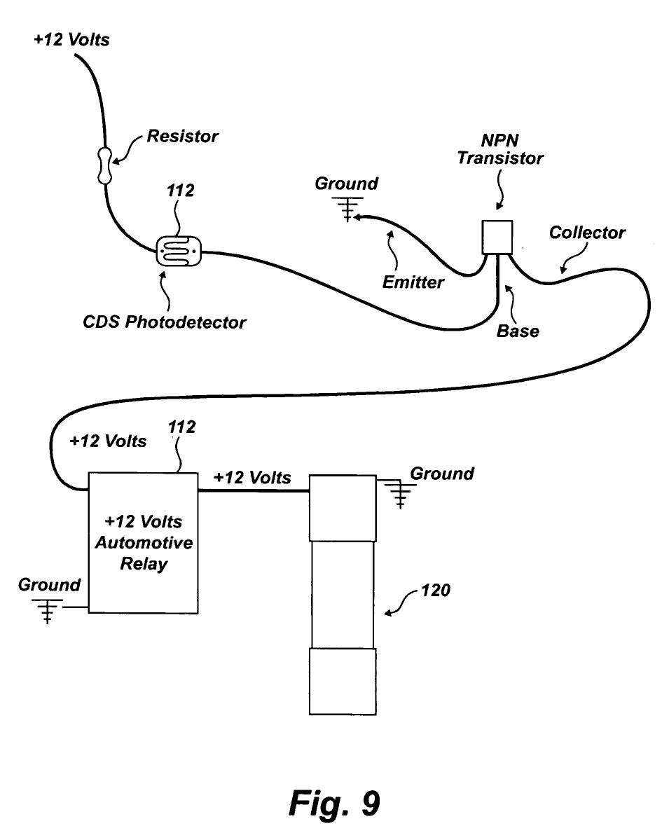

FIGS. 8 and 9 illustrate an exemplary hydraulic system that can be incorporated with the photosensors utilized in the laser targeting box 110 of FIG. 3. As will be appreciated, the hydraulic and sensing systems can be configured in a variety of manners to energize hydraulic valves (such as solenoid-driven valve 120 shown) to bi-directionally adjust hydraulic actuators 121 to adjust a vertical and/or horizontal position of the blade 20 and shoe 22.

In one embodiment, pressurized hydraulic fluid can flow through the hydraulic valve 120. The lines can be pressurized when solenoids receive a predetermined voltage. The voltage can be applied when the laser output is received at one of the photosensors 112. This can be accomplished using a switch such as an NPN transistor, with the emitter coupled to ground, the output of the photosensors coupled to the base, and the collector coupled to a relay 122. Thus, when the laser is detected at one of the photosensors, the appropriate hydraulic valve can be opened to move the blade 20 and shoe 22 in the horizontal or vertical direction to correct its location until the laser is properly aligned again. A hydraulic flow controller 123 can be used to control the direction of movement of the hydraulic actuator 121. The laser alignment system shown in FIG. 3 can be used to enable the trench bed to be accurately prepared for the placement of the pipe.

While the invention has been described as utilizing a laser system to track and control the grading process, it is to be understood that other guidance systems can be utilized with the present invention, including mechanical methods, such as physical guidewires, and other automated methods, such as global positioning systems (“GPS”), etc. Similarly, while the guidance control system has been shown utilizing a particular type of signal detecting apparatus, it is to be understood that a variety of signal detecting apparatuses can also be used.

The system can be powered and controlled in a variety of manners known to those skilled in the art. In the embodiment illustrated schematically in FIGS. 1 and 5 a centralized engine, hydraulic and control circuitry assembly can be located on the carriage 17 adjacent the hopper 32. In this illustrative example, the system is powered by a thirty net horsepower diesel engine which can power the hydraulic system, either directly or indirectly, and can also provide the power to drive the carriage along the length of the trench. The engine can be provided with an exhaust “scrubber” to clean the exhaust to prevent build-up of harmful gases within the trench. The control circuitry necessary to control the various hydraulic and/or electric components can also be located adjacent the hopper. Many of the hydraulic, electric and electronic components of the system will be familiar to those of ordinary skill in the art. As such, variations on the embodiments discussed herein are to be expected without deviating from the invention as disclosed herein.

While the system has been described above as generally preparing the floor of a trench to receive pipe, the carriage system can also be used in installing pipe on the trench floor, and in burying pipe installed on the trench floor. For example, it is contemplated that the blade of the carriage can adapted to exert force on sections of pipe to fit the pipe within the fittings of adjacent pipes. In addition, the hopper and conveyor system that are used to apply fill to the trench floor can also be used to bury the pipe after installation of the pipe has been completed.

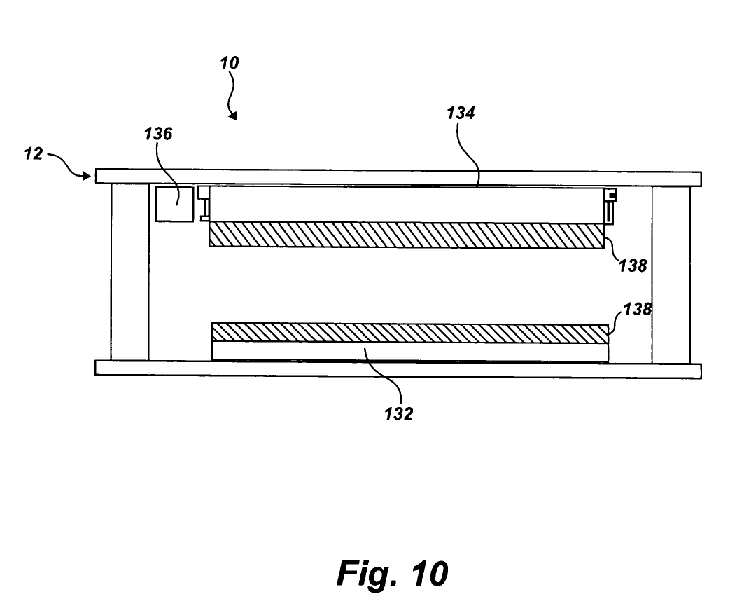

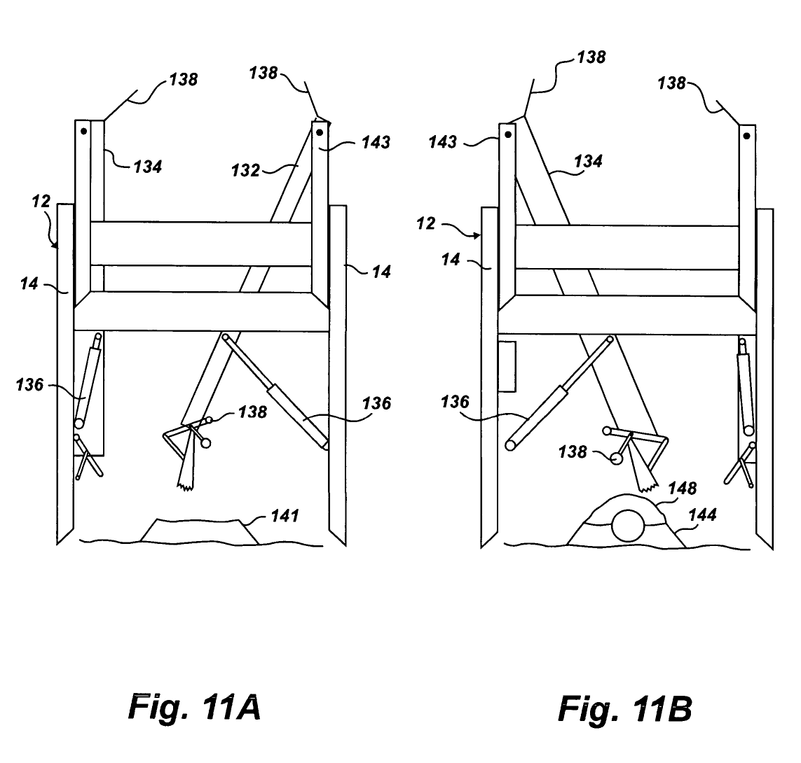

Turning now to FIGS. 10 through 12E, in another embodiment, the pipe bedding system 10 can include at least two different materials that are useful in forming a trench bed capable of supporting a pipe. For example, two or more separate hoppers can be coupled to or integrated within the trench support frame 12. A first hopper 132 can contain a concrete mixture. A concrete mixture supply apparatus can be coupled to the first hopper 132 and configured to provide a layer of concrete 141 (FIG. 11A) within the earthen trench. This aspect of the invention will be discussed in more detail below.

The concrete mixture can be a variety of types of aggregates that form, or are operable to form, a concrete material or a cement material. The concrete mixture may be stored in the hopper 132 in a substantially dry form. Alternatively, a hydrating solution such as water may be added while the concrete mixture is in the hopper. The hydrating solution can be stored in a tank coupled to the trench support frame 12 (FIG. 1), a tank external to the earthen trench (not shown), and/or a pressurized source external to the earthen trench (not shown). A second hopper 134 can be used to store a bedding material. Each hopper can be coupled to a catch plate 138 that can be opened outwardly from a respective hopper to aid in loading the desired material into each of the hoppers. A hydraulic pump 136 can be used to control the disbursement of the concrete mixture and bedding material onto the trench bed, as will be discussed in more detail below.

A front view of one embodiment of the pipe bedding system is shown in FIGS. 11A and 11B. FIG. 11A shows first and second hoppers 132 and 134 pivotally coupled to the trench support frame 12. The hoppers can be coupled to a hopper support 143 that is connected to the longitudinal supports 14. Alternatively, the hoppers can be coupled to the carriage 17 (FIG. 1) to enable the hoppers to move with the carriage along the length of the support frame 12. Each of the hoppers can be guided away from the trench support frame 12 in a variety of manners. In one embodiment, a hydraulic actuator 136 can be used to extend the hopper to a desired position within the trench support frame 12 over the floor of the trench on which pipe is to be laid.

FIG. 11A shows the first hopper 132 storing a concrete mixture actuated until concrete mixture can be dispensed at a desired location onto the floor of the trench. If the concrete mixture is stored in the hopper in a dry form then a hydrating solution such as water can be added to the mixture as it is dispensed from the hopper 132. A valve 138 can control the flow and direction of the hydrating solution as it is dispensed. In one embodiment, a combination of the hydrating solution dispensed from the valve and concrete mixture dispensed from the hopper 132 can be combined to allow formation of a layer of concrete 141 on the floor of the trench. The hopper 132 can be sized so as to extend substantially completely along the length of the trench box 12, or can be made movable and can move along the trench support frame over a desired length. The concrete layer 141 can be dispensed in a predetermined thickness over the desired length to form a support bed for a pipe.

The concrete layer 141 can be leveled and formed using a blade 20 and shoe 22, as shown in FIG. 4A and discussed previously. The leveled, formed concrete layer 144 can have a pipe placed within the center formed area, as shown in FIG. 11B. The second hopper 134 can then be used to dispense bedding material 148 over the top of the pipe and formed concrete layer 144. The bedding material 148 can be dispensed over the length of the pipe to enable the entire pipe to be covered by a layer having a predetermined thickness, as may be dictated by appropriate construction codes.

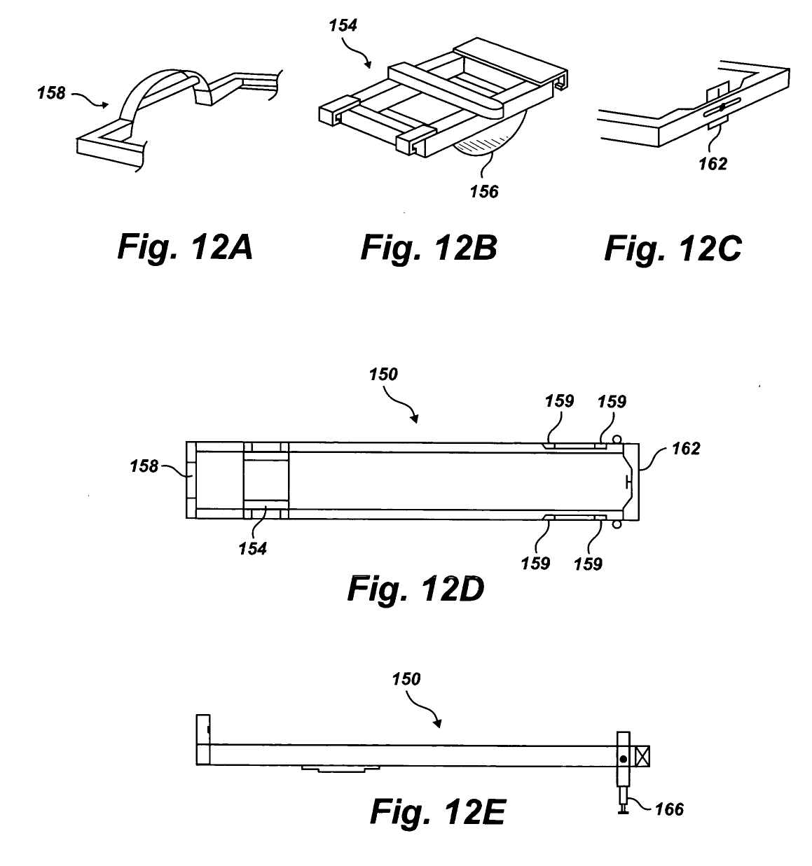

FIGS. 12A through 12E show an alternative embodiment for grading and forming the concrete layer 141 of FIG. 11A. A surface grading device or assembly 150 (FIGS. 12D and 12E) can be placed over the concrete slurry layer. A first side of the surface grading device or assembly 150 can include a pipe fitting apparatus 158 configured to fit over an end of a piece of pipe (that has already been leveled and laid). This enables the surface grading device 150 to level and form the concrete slurry for at least a length of a pipe from the point of a previously laid pipe, and also enables the system to be roughly level with the pre-existing pipe segment. A grading sled 154 can be slidably attached to the surface grading device 150. In one embodiment, the grading sled can be attached to the surface grading device at groove locations 159.

A channeling protrusion 156, similar to the protrusion attached to the shoe 22 in FIG. 4A, can extend downward from the sled. The channeling protrusion 156 can be used to gouge a channel in the uncured concrete layer 141 (FIG. 11A) which substantially matches the cross section of the pipe to be laid. In this manner, as the pipe is laid within the channel, the pipe is supported about much of its lower cross section by the cured concrete layer without requiring that additional fill material to be applied under and about the pipe, as shown in FIG. 4C. A plurality of grading sleds 154 can be formed, each having a different size channeling protrusion 156. A user can select and attach a grading sled 154 to the surface grading device 150 based upon the size of channel protrusion 156 needed for the pipe that is being laid.

A second side of the surface grading device 150 can include a target area 162 configured to receive a laser beam. The target area can enable the surface grading device 150 to be correctly position before the grading sled 154 is operated. The laser beam can be directed through previously laid pipe. Once the pipe fitting apparatus 158 on the first side of the surface grading device has been abutted with the previously laid pipe, the laser beam will be directed through the surface grading device 150 and onto the target area 162. The second side of the surface grading device 150 can be moved horizontally or vertically to line up properly with the target area 162.

The second side of the surface grading device 150 can be made height adjustable to allow the uncured concrete layer 141 to be leveled and formed at a predetermined slope. In one embodiment, the device 150 can be made height adjustable using threaded or otherwise adjustable feet 166. Other mechanical means may also be used to adjust the height of the second side of the surface grading device 150. Once the laser is within a selected region of the target area 162 then the grading sled 154 and channeling protrusion 156 can be actuated over a length of the surface grading device. One or more passes of the sled may be necessary to obtain the final grade.

The grading sled 154 can be manually actuated over the uncured concrete or may be mechanically moved using electric motors, guide wires, or the like. To facilitate manual actuation of the sled, handles (not shown) or other similar structure can be incorporated onto or into the sled. The surface grading device 150 can be formed of a lightweight, relatively strong material such as aluminum so as to be easily portable and easily maneuvered into and out of the trench box 12. In one aspect of the invention, the entire surface grading device is manually lifted and installed into place when needed. After the uncured concrete has been “finished” by the grading sled, the surface grading device can be lifted by hand and either removed from the trench to allow the trench box to be moved, or can be hung on suitable structure within the trench box while the trench box is moved. In addition, it is contemplated that the surface grading device or assembly 150 can be incorporated into structure suitable to hydraulically, mechanically or electrically move the surface grading device into position over the uncured concrete layer.

Once the uncured concrete layer 141 is graded to a desired level and the channel is formed using the channeling protrusion 156, a pipe can be placed into the channel and fitted into the previously laid pipe using methods known to those having ordinary skill in the art. In one embodiment, the pipe can be laid with the surface grading device removed from over the uncured concrete layer. The second hopper 134, as shown in FIGS. 10 and 11B, can then be used to spread a layer of bedding material 148 over the length of the pipe. The use of the hoppers to prepare the trench bed for receiving one or more pipes can substantially decrease the amount of time needed to lay pipe. As previously discussed, laying pipe can require large amounts of expensive machinery and personnel. The present invention, as disclosed in the several embodiments, can decrease the time needed to lay pipe and reduce the overall costs.

In addition to the structural features discussed above, the present invention also provides a method for preparing an earthen bed for installation of pipe thereon, including the steps of: placing a trench support frame at least partially within an earthen trench in which pipe is to be installed; providing a bedding material within the earthen trench on which the pipe is to be installed, wherein the bedding material is provided using a bedding material supply apparatus integrated with the trench support frame; and forming a channel in the bedding material, the channel configured to receive the pipe to be installed, wherein the channel is formed using a surface grading device associated with the trench support frame.

Forming a channel can further comprise forming a channel in the bedding material wherein the channel is shaped to substantially match a cross section of the pipe to be installed. Providing a bedding material can further comprise providing a bedding material on which the pipe is to be installed including at least one bedding material from the group consisting of a concrete mixture, an earthen bedding material, a concrete slurry, and a substantially incompressible material. The method can include the further acts of providing a fill material over the pipe installed within the channel using a fill material supply apparatus integrated within the trench support frame. A hydrating solution can be added to at least one of the bedding material and the fill material.

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred embodiment(s) of the invention, it will be apparent to those of ordinary skill in the art that numerous modifications can be made without departing from the principles and concepts of the invention as set forth herein.

I claim:

1. A system for preparing earthen beds for installation of pipe thereon, comprising:
a trench support frame, disposable at least partially within an earthen trench in which pipe is to be installed;
a grading assembly coupled to the trench support frame, at least a portion of which is movable within the trench support frame; and
a bedding material supply system, integrated with the trench support frame, the bedding material supply system being configured to provide bedding material to be graded by the grading assembly to prepare a floor of the earthen trench for installation of the pipe within the trench.

2. The system of claim 1, wherein the bedding material is comprised of a fill material selected from the group consisting of: soil, road base, and a concrete mixture.

3. The system of claim 1, wherein the grading assembly further comprises:
a leading blade; and
a trailing shoe pivotally coupled to the leading blade, the leading blade and the trailing shoe being configured to grade and compact bedding material over which the blade and shoe travel.

4. The system of claim 3, wherein the shoe is adjustable with respect to the leading blade to increase or decrease a relative angle between the leading blade and the trailing shoe to increase or decrease, respectively, a level of compaction of bedding material past which the blade and the shoe travel.

5. The system of claim 3, further comprising a channeling protrusion extending downwardly from the shoe, the channeling protrusion being configured to gouge a channel in the bedding material for receiving lengths of pipe therein.

6. The system of claim 5, wherein the channeling protrusion is configured to gouge a channel in the bedding material which substantially matches a cross section of the pipe to be installed in the earthen trench.

7. The system of claim 5, further comprising a guidance system, operatively coupled to at least one of the trench support frame and the grading assembly, wherein the guidance system is configured to enable adjustment of the grading assembly to maintain a desired grade within the earthen trench and a desired directionality of the channel gouged in the bedding material.

8. The system of claim 7, wherein the guidance system further comprises a detector array operable to detect a laser beam.

9. The system of claim 8, wherein the detector array is coupled to control circuitry configured to activate at least one of a horizontal piston and a vertical piston to adjust a level and a position of the blade and the shoe to enable the desired grade and the directionality of the channel to be maintained within a predetermined parameter.

10. A system for preparing earthen beds for installation of pipe thereon, comprising:
a trench support frame, disposable at least partially within an earthen trench in which pipe is to be installed;
a surface grading device associated with the trench support frame; and
a concrete mixture supply apparatus, integrated with the trench support frame, the concrete mixture supply apparatus being configured to provide a layer of concrete within the earthen trench, the layer of concrete to be graded by the surface grading device to prepare the layer of concrete for installation of the pipe within the earthen trench.

11. The system of claim 10, further comprising a grading sled slidably attached to the surface grading device, the grading sled configured to grade the layer of concrete.

12. The system of claim 11, further comprising a channeling protrusion coupled to the grading sled, the channeling protrusion being configured to gouge a channel in the layer of concrete.

13. The system of claim 12, wherein a shape of the channel substantially matches a cross section of the pipe to be installed.

14. The system of claim 10, wherein a first end of the surface grading device further comprises a fitting configured to substantially match a portion of a previously installed pipe.

15. The system of claim 10, wherein a second end of the surface grading device further comprises a target area configured to receive a laser beam to enable the surface grading device to be correctly positioned before the grading sled is actuated.

16. The system of claim 10, further comprising a fill material supply apparatus, integrated with the trench support frame, the fill material supply apparatus being configured to provide fill material over a pipe installed in the earthen trench.

17. The system of claim 10, further comprising a valve associated with the concrete mixture supply apparatus, the valve configured to control dispensation of a hydrating solution as the concrete mixture is dispensed, wherein the hydrating solution is configured to be combined with the concrete mixture dispensed from the concrete mixture supply apparatus to form the layer of concrete.

18. The system of claim 17, wherein the hydrating solution is comprised substantially of water.

19. The system of claim 18, wherein the water is stored in one of a tank coupled to the trench support frame, a tank external to the earthen trench, and a pressurized source external to the earthen trench.

20. A method for preparing an earthen bed for installation of pipe thereon, comprising:
placing a trench support frame at least partially within an earthen trench in which pipe is to be installed;
providing a bedding material within the earthen trench on which the pipe is to be installed, wherein the bedding material is provided using a bedding material supply apparatus integrated with the trench support frame; and
forming a channel in the bedding material, the channel configured to receive the pipe to be installed, wherein the channel is formed using a surface grading device associated with the trench support frame.

21. The method of claim 20, wherein forming a channel further comprises forming a channel in the bedding material wherein the channel is shaped to substantially match a cross section of the pipe to be installed.

22. The method of claim 20, wherein providing a bedding material further comprises providing a bedding material on which the pipe is to be installed including at least one bedding material from the group consisting of a concrete mixture, an earthen bedding material, a concrete slurry, and a substantially incompressible material.

23. The method of claim 20, further comprising providing a fill material over the pipe installed within the channel using a fill material supply apparatus integrated within the trench support frame.

24. The method of claim 20, further comprising adding a hydrating solution to at least one of the bedding material and the fill material.
